(19) United States
(12) Patent Application Publication
(10) Pub. No.: US 2012/0210005 A1
(43) Pub. Date: Aug. 16, 2012

(54) METHOD AND DEVICE FOR PROCESSING DATA IN A NETWORK DOMAIN

(75) Inventors: Mohit Chamania, Braunschweig (DE); Bernhard Lichtinger, Garching B. Muenchen (DE); Marco Hoffmann, Muenchen (DE); Clara Kronbeger, Muenchen (DE); Franz Rambach, Muenchen (DE)

(73) Assignee: NOKIA SIEMENS NETWORKS OY, ESPOO (FI)

(21) Appl. No.: 13/501,517

(22) PCT Filed: Oct. 12, 2009
(86) PCT No.: PCT/EP09/63289

§ 371 Date: May 8, 2012

(51) Int. Cl. G06F 15/173

(52) U.S. Cl. 709/226

(57) ABSTRACT

A method and a device for processing data in a network domain. The resources of several layers of at least two network elements of the network domain are determined. The thus determined resources are utilized for path processing in the network domain. Furthermore, a communication system is provided with the device.

The invention relates to a method and to a device for processing data in a network domain and a communication network comprising such a device.

A Generalized Multi-Protocol Label Switching (GMPLS) architecture refers to a set of protocols, including routing protocols (OSPF-TE or ISIS-TE), link management protocols (LMP), and reservation/label distribution protocols (RSVP-TE, CR-LDP). The GMPLS architecture is based on IETF RFC 3945.

Domains may usually be set up encapsulating a collection of network elements, control functions or switching functions and in particular hiding their internal structure to the outside world, be it for privacy, scalability or other reasons.

Current communication networks provide connectivity to many areas and operators. This degree of connectivity requires compatibility between different network domains, e.g., in terms of used protocols, interfaces or quality of service (QoS).

A communication network comprises several layers, e.g., according to the OSI model. Each layer provides a service to its upper layer and utilizes the service provided from its subjacent layer.

A control plane is known in particular to provide signaling and/or routing services in a network. The control plane is provided for a single layer only.

A management plane can be utilized to perform FCAPS (fault, configuration, accounting, performance, security) tasks within the network. In special cases, the management plane may also conduct tasks usually performed by the control plane.

Currently, separate management systems exist for different network layers and for different vendors.

A path computation element (PCE) is an entity that calculates a path across the network or a portion thereof. The PCE may use various routing algorithms and thus may apply different path computation rules. The network information can be stored in a specified traffic engineering data base (TED), which is used by the PCE for path computation purposes. Communication between PCEs or between a path computation client (PCC) and the PCE could be utilized via a PCE communication protocol (PCECP). Based on such encoded request received by the PCE, the PCE computes the resources to be allocated (i.e., the “path”) for a (virtual) circuit between several (virtual) circuit endpoints. The PCECP may be based on IETF RFC 5440.

Network operators use different concepts and architectures to control and manage their networks. Optimizing the network is difficult even for a single operator, because of the architecture and diversity of the network.

In addition, a connection between providers even complicates the situation as the number of networks and thus the degree of diversity increases. Furthermore, providers are not merely exchanging information regarding connectivity issues, but require negotiation of quality of service conditions as well as prices of the services offered. Service level agreements (SLA) may have to be agreed upon defining the conditions of a service. Today, an inter-domain service setup is conducted manually and coordinated by email or fax. This is time-consuming, error-prone and thus inflicts high OPEX.

The problem to be solved is to overcome the disadvantages pointed out above and in particular to provide an efficient approach to allow for a multi-layer optimization utilizing, e.g., various management and control plane technologies.

This problem is solved according to the features of the independent claims. Further embodiments result from the depending claims.

In order to overcome this problem, a method is provided for processing data in a network domain,
wherein resources of several layers of at least two network elements of the network domain are determined;
wherein the resources determined are utilized for path processing in the network domain.

Said several layers may be at least two, in particular three or more layers of each network element of the network domain.

This concept of considering several layers of several network elements could be regarded as utilizing several layers of several network elements for path processing purposes and thereby utilizing resources of several layers across several network elements in an optimized fashion. For example, such approach may not only consider resources of layer-2 for path computation purposes, but also resources or pre-settings of other layers (e.g., requirements due to SLA, policies or QoS restrictions) in order to find, e.g., a suitable path (or resource) in the domain.

It is noted that the path mentioned herein could refer to different kinds of connections, e.g., temporarily active paths, virtual paths, multiplexed slots, circuit-switched or packet-switched connections, deterministic or non-deterministic traffic, etc.

Advantageously, the approach suggested allows optimizing a network across multiple layers and/or across control and management planes of various layers. A multi-layer optimization (MLO) can thus significantly reduce capital expenditures (CAPEX) and operational expenditures (OPEX).

In an embodiment, such path processing comprises path computation and/or routing across the network domain or preparatory actions thereof.

These preparatory actions may in particular comprise resource determination and/or resource allocation required for routing purposes.

Said routing across the network domain may refer to a routing across the whole network domain or a portion thereof.

In another embodiment, said path processing in the network domain comprises a connection setup.

It is noted that such connection could refer to a path that is set up or established within the network domain across the network domain or across several network domains. The current network domain could in particular be a part of an end-to-end path across several domains. Such several domains may be driven by different provider and/or utilize (at least partially) different technologies.

In a further embodiment, the resources are determined by a centralized component of the network domain, in particular by a path computation element (PCE).

It is noted that such path computation element could be based on a functionality provided by a known and/or available PCE.

As an option, several centralized components can be deployed with the network domain. The several centralized components may in particular share tasks, e.g., one centralized component may process intra-domain tasks, wherein another centralized component may compute path information or determine resources across several domains.

In a next embodiment, the resources are determined via at least one control plane and/or via at least one management plane of the network domain.

A control plane may be associated with at least one layer of the network elements; also, the management plane may be associated with at least one layer of the network elements.

The management plane and/or the control plane may have an interface to the centralized component conducting path computation services. Such interface can be realized as a client, in particular a PCC utilizing a PCECP.

It is noted that the management plane may comprise and/or take over functionalities that are otherwise provided by the control plane.

It is also an embodiment that the management plane comprises at least one of the following:
a service management system;
a network management system;
an element management system.

Pursuant to another embodiment, the management plane and/or the control plane provides in particular at least one of the following:
fault management;
configuration services;
accounting services;
performance services;
security services.

According to an embodiment, the network element comprises a management plane functionality.

In particular, the network element (NE) may be supplied with at least one function of the management plane. Thus, the NE may in particular be configured via the element management system (utilizing, e.g., SNMP as a communication means) and the NE may provide alarming messages toward the management plane.

It is noted that the centralized component can be associated with a database (also referred to as traffic engineering database—TED); this database can be initialized by a database of the management plane, in particular by a database of the network management system. In addition, this database of the network management system can be updated by the TED.

According to another embodiment, the management plane and/or the control plane provides at least one of the following functions:
a determination of adjacent network elements and/or domains;
a distribution of topology and/or resource status information;
a path computation functionality;
routing functions;
signaling functions.

It is noted that the path computation functionality may in particular apply in case it is not provided by the centralized path computation element or in case it is not utilized otherwise. As an option, the path computation functionality may be conducted by the management plane and/or control plane in case of predetermined scenarios (e.g., if it is more efficient to compute the path locally without any centralized component being involved).

In yet another embodiment, the control plane is supplied within a GMPLS implementation for several layers of the network elements.

The layers of the network may in particular at least partially be utilized pursuant to the GMPLS architecture.

According to a next embodiment, a path across several domains is processed utilizing the resources determined in the network domain.

Hence, in particular several domains may follow the same approach and determine a path across the respective domains. An initiating domain may be provided with path information from each subsequent domain or the path could be propagated across several domains, one domain after the other (“hop-by-hop” across domains). This efficiently enables setting up and utilizing resources of an end-to-end path across several domains.

It is noted that the multi-layer optimized approach does not have to apply for any other domain.

It is another advantage that the approach allows for an automated information exchange between several domains, in particular operated by different (and/or several) providers.

In particular due to the functional separation between control plane, management plane and PCE, an efficient end-to-end connection set-up between and/or across provider domains can be conducted using different control and management technologies. Additionally such a functional separation is beneficial for MLO and therefore provides a solution for both challenges: MLO and multi-domain automated connection setup.

As an option, processing data can be provided across several domains of a network,
wherein resources of several domains of the network are determined;
wherein the resources determined are utilized for path processing in the network.

Hence, a path across a network (or a portion of such network) can be determined by utilizing at least two domains of this network. As the domains may be (at least to some extent) separate units, the processing of data, e.g., via a path (to be determined), is coordinated across such domains to increase an overall efficiency or performance and/or to consider requirements or constraints defined, e.g., by service level agreements (SLAs).

Optionally, the resources of the several domains may be determined by a management system of a first domain.

Hence, the path across the several domains can be determined by the management system of the first domain.

The management system of the first domain may trigger at least one management system of another domain and receives a path information from this at least one management system of another domain.

The path information may be gathered by the management system of the first domain to form the (total) path across several domains (or a portion of such path).

It is an option that the management system of the first domain triggers a subsequent domain and a management system of the subsequent domain further determines resources along the path.

Hence, the management system of the subsequent domain may trigger a management system of another domain and this may trigger a further management system of an adjacent domain and so forth. The management system of the subsequent domain may provide information, in particular path and/or routing information, back to the management system of the first domain.

The overall path processing may thus be administered by the first domain utilizing partial path information from further domains along the path obtained via a request-response mechanism. The overall path processing could also be initiated by the first domain providing information required to the subsequent domain, which then triggers another domain; this way, the path processing is achieved on a hop-by-hop basis from one domain to another (the first domain does not have to administer and collect information regarding the overall path).

According to a further embodiment,
the resources are at least partially determined by several centralized components,
each centralized component is a computation element of one domain, and
the computation elements of several domains collaborate with each other said computation elements to determine resources that are used for path processing purposes across several domains of the network.

Said computation element could be a path computation element and/or an extended existing path computation element.

The problem stated above is also solved by a device comprising or being associated with a processing unit that is arranged such that the method as described herein is executable thereon.

Said processing unit may comprise at least one of the following: a processor, a microcontroller, a hard-wired circuit, an ASIC, an FPGA, a logic device.

Pursuant to yet an embodiment, the device is a network element, in particular a node of a communication network.

The problem stated supra is further solved by a communication system comprising at least one device as described herein.

Embodiments of the invention are shown and illustrated in the following figures:

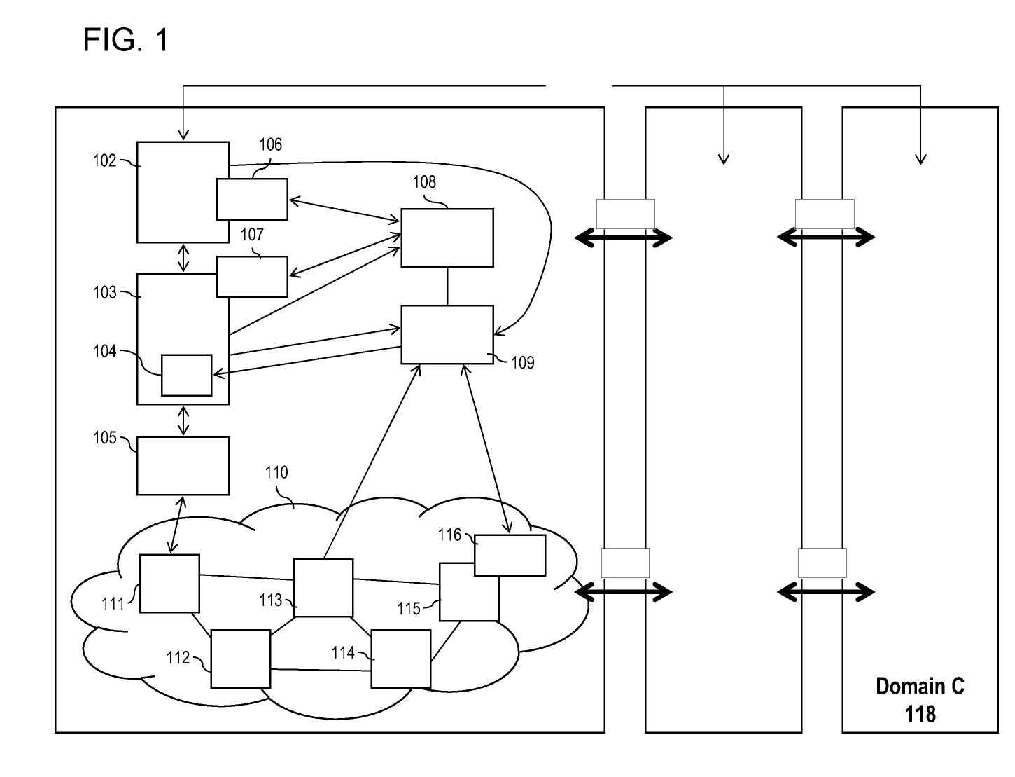

FIG. 1 shows a block diagram of a several domains visualizing in particular building blocks in a first domain, said building blocks providing management plane and control plane functionality together with a centralized path computation element utilized by a GMPLS network; path processing is enabled within the domain by a multi-layer approach and/or across the several domains shown;

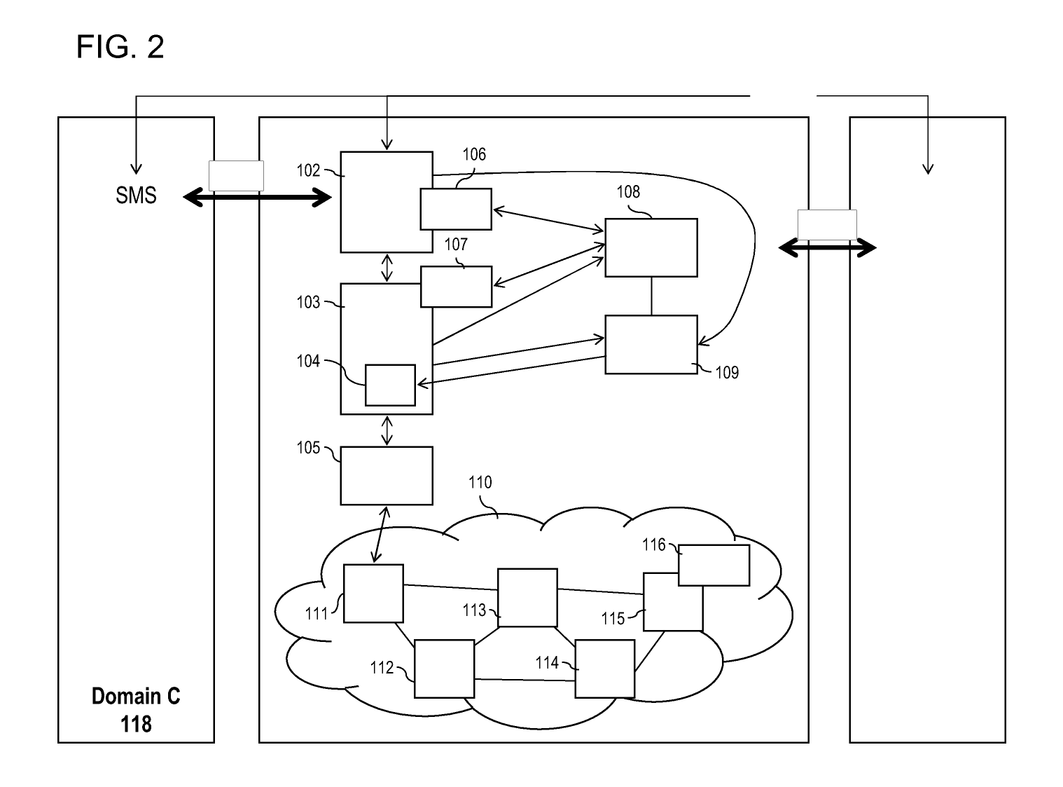

FIG. 2 shows a block diagram based on FIG. 1, wherein an adjacent domain does not have a centralized path computation function;

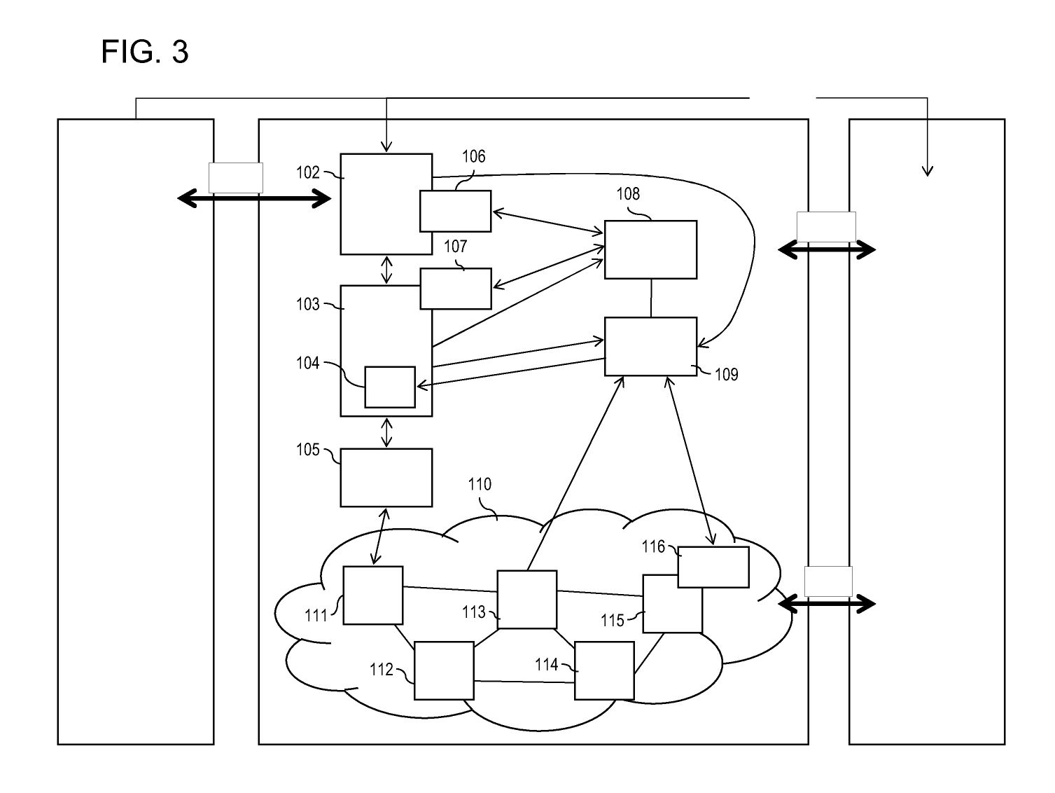

FIG. 3 shows a block diagram based on FIG. 1, wherein an adjacent domain does neither have a CP nor a centralized PCE.

The approach suggested in particular provides a solution for an automatic multi-domain connection setup between different management and different control plane technologies of various operators. Advantageously, an improved migration scenario is suggested also to allow a rather unimpeded change towards future scenarios (comprising, e.g., a centralized NMS that can also be used for connection provisioning and resilience, a fully automated control plane over multiple layers or technologies with an optimized signaling, routing and connection set up).

Both architectures will be described in detail. Additionally, a functional separation between control plane (CP), management plane (MP) and a PCE is suggested. Also relevant interfaces will be defined. This efficiently enables MLO for at least one domain of a network (or at least a portion thereof) and may reduce the amount of redundant data bases required.

The building blocks management plane (MP), control plane (CP) and path computation element (PCE) can in particular be efficiently arranged. In order to allow for an efficient multi-layer traffic engineering (TE) and/or a multi-domain connectivity, the communication between these building blocks will be defined in particular for an integrated solution that may preferably be compatible (at least to a certain extent) with existing equipment.

Hereinafter, the building blocks and their functionalities are described in more detail.

### Management Plane (MP):

The management plane implements or provides FCAPS (fault, configuration, accounting, performance, security) functionalities. It comprises in particular service managements system(s) (SMS), network management system(s) (NMS), element management system(s) (EMS) and management software inside the network elements (NE).

### (1) SMS:

The SMS is on top of at least one NMS and may establish management connections to service management of other providers. The service management has an abstract view of the networks managed by the NMS. Furthermore, the SMS may be aware of connections between single management (edge) domains.

### (2) NMS:

The NMS may either be responsible for at least one layer and/or technology. It can in particular be responsible for multiple layers and/or technologies.
Each NMS may comprise or have access to (at least one) database that stores data of its NMS domain and is periodically updated (e.g., every 15 minutes) via, e.g., messages of an SNMP (Simple Network Management Protocol).
Furthermore, the NMS may comprise a path computation client (PCC) to communicate with the PCE, in particular to request a calculated path from the PCE.
Within a provider domain, the management systems can be deployed in a recursive tree of management systems. As an exemplary embodiment, the at least one NMS is deployed below the SMS and further the EMSs are arranged below the NMSs.

### (3) EMS:

The EMS provides functionalities to communicate with one or more types of NEs. The EMS communicates upwards with the NMS. It receives a configuration trigger for the NEs from the NMS and conveys information gathered from the NEs towards the NMS.

### (4) Management Software Inside the Network Element (NE):

The management plane inside the NE can be implemented by executing management protocols, e.g., SNMP with the respective NE. Via such management protocols, the EMS can configure the NEs and the NEs can send alarming messages to the NMS via the EMS.

### Path Computation Element (PCE):

The PCE is an entity that is capable of computing a network path or a route based on, e.g., a network topology (which can be described as a network graph). During such computation, the PCE may apply or utilize requirements, policies or constraints.

The PCE may utilize a traffic engineering database (TED), which may comprise at least one database that is accessible for the PCE and may be deployed within the network or in particular with the PCE. The TED may be realized as a distributed database; it may also be located or be associated with the PCE.

In an exemplary embodiment, one PCE and one TED could be provided per technology, per layer and/or per vendor. It is also an option to provide one PCE and one TED for each inner domain of a provider or to deploy one PCE with one TED for all layers, all technologies and/or all vendors of at least one domain of a provider. Also combinations or selections thereof are applicable. As another example, a hierarchical PCE organization can be provided in one domain of a provider (e.g., one PCE for each inner provider domain and one PCE for multi-domain path computation purposes). The TED can be updated with actual traffic engineering parameters via an extended interior gateway protocol (IGP, e.g., OSPF-TE) and/or with SLA data. One option is to allow the PCE a total view on all network parameters to provide a full-blown (e.g., optimal) path calculation.

### Control Plane (CP):

The CP has different tasks, comprising, e.g., automatic neighbor discovery, topology and resource status dissemination, path computation (e.g., if not done by PCE), routing, signaling for connection provisioning. These functionalities can be realized executing different protocols inside an NE and/or between NEs.

As an example, the control plane can be provided as a GMPLS implementation in the network for all layers.

### Building Block Arrangement:

An exemplary arrangement of building blocks is shown in FIG. 1. A domain A 101 comprises a SMS 102, a NMS 103 with a database DB 104 and an EMS 105. The SMS 102 comprises a PCC 106 and the NMS 103 comprises a PCC 107. The domain A 101 further contains a PCE 108 that is connected to a TED 109; it is noted that the TED 109 can be deployed with the PCE 108 as well.

It is noted that several NMS and several EMS could be provided within the domain A 101.

The domain A 101 further comprises a GMPLS network 110 with several NEs 111 to 115, which are interconnected. The NE 115 comprises a PCC 116.

The elements shown within domain A 101 exchange messages or communicate via different interfaces: The PCC 106 of the SMS 102 communicates with the PCE 108 using the PCECP; also, the PCC 107 of the NMS 103 communicates with the PCE 108 via the PCECP. The SMS 102 may update the TED 109. The NMS 103 configures the PCE 108 and initializes the TED 109. The PCE 108 (in particular the TED 109) may update the database DB 104 of the NMS. The SMS 102 and the NMS 103 may communicate via an MTOSI and the NMS 103 and the EMS 105 may communicate via an MTOSI. The EMS 105 and the NEs 111 to 115 may communicate via SNMP. The NEs 111 to 115 may convey OSPF-TE information to the PCE 108 or TED 109 and the PCC 116 of the NE 115 may communicate with the PCE 108 or TED 109.

It is noted that all network elements NE 111 to 115 may communicate with the PCE 108 or TED 109 as indicated for NEs 113 and 116. In addition, all network elements NE 111 to 115 may communicate with the EMS 105 as exemplary indicated for NE 111.

The GMPLS network 110 may comprise several layer, i.e. each network element NE 111 to 115 may comprise several layers, each of which (or some layer) may provide information towards the PCE 108. This allows for multi-layer optimization across several layers of several network elements within the GMPLS network 110.

A domain B 117 and a domain C 118 are shown in FIG. 1 as well, wherein each domain B, C comprises a SMS, a PCE and a GMPLS network. The SMSs of the domains A, B and C communicate via a BGP, the PCEs of the domains A, B and C communicate via the PCECP and the GMPLS networks of the domains A, B and C communicate via an E-NNI.

It is noted that the PCE 108 and the TED 109 may be regarded as a single logical entity also referred to as PCE (with database TED). Hence, communication to the TED may be interpreted as a logical communication towards the TED via the PCE.

As described, the SMS 102 has an interface to the NMS 103 and the NMS 103 has an interface to the EMS 105. The PCE 108 (and thus the TED 109) communicates with the NEs (in particular with the NE 115 comprising the PCC 116) and with the NMS 103.

Hence, the TED 109 of the PCE 108 can be initialized via the database DB 104 of the NMS 103 and this database DB 104 can also be updated by the TED.

### Interfaces

In the following the interfaces used for the two approaches (MP based architecture and CP based architecture) are explained:

### (1) Management Plane Based Architecture:

Every domain may have one unified NMS. Hence, all layers of the domain are controlled and managed via the same NMS. The SMS and NMS can have an interface to the PCE for intra- and/or inter-domain path computation purposes or the path computation can be conducted internally by the SMS and/or by the NMS. Such architecture is shown in FIG. 2.
FIG. 2 is based on the structure shown in FIG. 1. Reference signs correspond to the ones used in FIG. 1. Accordingly, the explanations on FIG. 1 may apply as well. However, in FIG. 2 the domain C 118 does not have a PCE and the SMS of domain A 101 and domain C 118 communicate via a MTOSI. In this case, the entities of the MP communicate with one another. The domain B 117 comprises a PCE, which allows communication with the PCE 108 of domain A 101.
Hereinafter, the interfaces between various components are described in more detail, wherein “A-B” indicates an interface between component A and component B:
   SMS-SMS:
      An interface (e.g., a MTOSI) can be used to trigger inter-domain service setup, maintenance, and teardown with an automated interface.
      A web service interface can be used to exchange connectivity information and service offerings (service templates).
   SMS-NMS:
      A standardized interface can be used, e.g., MTOSI, TMF.
      An intra-domain service setup, maintenance and/or teardown can be conducted via this interface.
      The interface can be used for configuration or for monitoring of services.
      The interface can be used for reception of performance data and alarms in case of failures or service degradation.
      The interface can be used for mapping of service instances to network resources.
   NMS-EMS:
      A standardized interface can be used, e.g., MTOSI, TMF.
      The interface can be used for configuration of connections between network elements.
      The interface can be used for setting up monitoring and thresholds according to established services.
   EMS-NE:
      A proprietary interface or SNMP can be used.
      The interface can be used for configuration of the NEs.
      The interface can be used for collecting logs and alerts from the NEs.
   SMS-PCE:
      The SMS may use information available in the service templates of different domains to update the TED for preferred inter-domain chains based on services requested.
      The SMS may also use the PCE to compute available transit information to create and advertise its own service templates.
      The SMS can also configure rules for inter-domain path computation based on policy agreements with different domains.
   NMS-PCE:
      The PCE is used for path calculation purposes.
      The NMS can initialize the TED with static information not advertised in routing protocols. This is especially useful for optical networks, wherein a number of parameters relating to signal quality are static and not advertised in routing protocols.
      The NMS can use this interface to configure the path computation algorithm used by the PCE.
   PCE-PCE:
      The PCECP can be used for communication purposes between PCEs.
      Such communication between PCEs can be utilized for multi-layer path computation and/or for multi-domain path computation.
      The PCE may request sub-paths from other PCEs.
These interfaces allow computing of a complete end-to-end (e2e) path even in case there is no PCE available in some domains. These interfaces are of particular advantage during a migration stage when both architectures, MP-based and CP-based, are supported in various domains.
   PCE-NMS:
      The PCE may request a path computation for another domain from the NMS. The NMS provides such path computation to the PCE.
      This interface can be used to connect an MP-based domain with a CP-based domain (and vice versa).
   NMS-SMS:
      The NMS forwards an inter-domain path computation received from the PCE to the SMS. The SMS replies to the NMS.
It is noted that the SMS and the NMS can be implemented as a single piece of software; in such case, the interfaces between the SMS and NMS may be implemented within this software and may not exist as external interfaces.

### (2) Control Plane Based Architecture:

In this scenario, every domain has one multi-layer PCE that can compute an optimal multi-layer path within its domain. Additionally, PCEs of different domains may interact to compute an e2e path. The common control plane can be used for service setup purposes and/or for intra-domain and/or inter-domain signaling and/or routing. This scenario is shown in FIG. 1.
   SMS-SMS:
      A web-based interface can be used to exchange service templates in order to establish new relationships.
      Routing protocols running between domains with existing SLAB can be used to compute multi-domain routes.
      SLA definitions may include capabilities for offering a service across multi-domains and/or capabilities for transit services to other neighboring domains.
   SMS-NMS:
      A standardized interface can be used, e.g., MTOSI.
      The interface can be used for intra-domain service setup, maintenance and/or teardown.
      The interface can be used for configuration or monitoring of services.
      The interface can be used for reception of performance data and alarms in case of failures or service degradation.
   NMS-EMS:
      A standardized interface can be used, e.g., MTOSI.
      The interface can be used for collecting logs and alarms from the EMS.
   EMS-NE:
      A proprietary interface or SNMP can be used.
      The interface can be used for configuration of the NEs.
      The interface can be used for collecting logs and alerts from the NEs.
   SMS-PCE:
      The SMS may use information available in the service templates of different domains to update the TED for preferred inter-domain chains based on services requested.
      The SMS may also use the PCE to compute available transit information to create and advertise its own service template.
      The SMS can also configure rules for inter-domain path computation based on policy agreements with different domains.
   NMS-PCE:
      The NMS can initialize the TED with static information not advertised in routing protocols. This is especially useful for optical networks, wherein a number of parameters relating to signal quality are static and not advertised in routing protocols.
      The NMS can update its own database via the TED, which may preferably provide up-to-date topology information.
      The NMS can use this interface to configure the path computation algorithm used by the PCE.
   PCE-PCE:
      This interface can be used to compute inter-domain paths using the PCECP.
      The PCE uses rules configured by the NMS to compute path segments to a destination node or between border nodes for transit, wherein path computation may consider different policies for different requesting domains.
   CP-CP:
      An interface such as an E-NNI running in the control plane may allow for data plane interworking between different domains.
      The E-NNI can also be used for translation purposes when operating across domains with different control planes.
      The CP-CP interface can be used to propagate path setup signaling and/or routing across multiple domains.
      The CP-CP interface can also be used for automated multi-domain alarm and recovery signaling in cases of multi-domain protection scenarios.
   CP-PCE:
      The CP, i.e. a NE using a PCC, can request a path computation from the PCE.
      The PCE may send a computed path back to the NE.
      Communication is realized using the PCECP.
   NMS-CP:
      This interface can be used for triggering the CP in order to setup, change and/or teardown connections and corresponding monitoring parameters.
These interfaces allow computing a complete e2e path even if there is no PCE available in some domains. These interfaces are of particular advantage during a migration stage when both architectures MP-based and CP-based are supported in various domains.
   PCE-NMS:
      The PCE may request a path computation for another domain from the NMS. The NMS provides such path computation to the PCE.
      This interface can be used to connect an MP-based domain with a CP-based domain (and vice versa).
   NMS-SMS:
      The NMS forwards an inter-domain path computation received from the PCE to the SMS. The SMS replies to the NMS.

### Migration Scenarios

### (1) Management Plane Approach:

In existing multi-domain systems, multi-domain service provisioning is performed by communication between the SMS-SMS interfaces of various management domains. There is no globally accepted standard as of now, and therefore no single protocol can be used to communicate with every other SMS system. In the migration scenario, the MTOSI will be introduced as a means for communication between management plane systems. The same protocol can be used between the SMS and the NMS as well as between the NMS and the EMS as shown in FIG. 3.
FIG. 3 is based on the structure shown in FIG. 1. Reference signs correspond to the ones used in FIG. 1. Accordingly, the explanations on FIG. 1 may apply as well. In contrast to FIG. 1, FIG. 3 shows a domain C 118 with no CP and no PCE, the SMS of the domain C 118 communicates with the SMS 102 of the domain A 101 via an interface, e.g., a MTSOI. It is noted that MTOSI is mentioned as an exemplary interface. Other interfaces may be applicable as well.
The service computation request can be sent along the SMSs of the domain chain. In case the source has a relationship with all domains of the domain chain, the source SMS can send individual service requests to each domain, and thus be aware of the QoS characteristics provided in each domain. On the other hand, in a chain based policy architecture, the SMS of the source domain may not be aware of the QoS characteristics of the different domains along the domain chain.
The path computation signaling using, e.g., MTOSI is similar to the PCECP signaling and uses similar mechanisms such as the BRPC to compute multi-domain paths. After path computation, the SMS of the source domain signals the remote SMSs of the path segments to be set up in their domains and hence conduct the multi-domain path setup. The actual path setup in each domain can be facilitated by the NMS.

### (2) Control Plane Approach:

A final phase of the control plane based approach may use the PCECP protocol for multi-domain path computation purposes, whereas reservation protocols can be used in the control plane for path setup purposes.
In a migration phase however, it may be possible that some domains do not have a PCE for inter-domain path computation. Therefore, if all domains in the domain chain are supplied with a PCE, the PCECP protocol can be used to compute inter-domain paths.
However, in a chain based policy system, the source domain may not be aware whether or not a remote domain is supplied with a PCE. In such scenario, the first domain to encounter a neighbor without a PCE may convert the parameters of the PCECP request, and then use the SMS-SMS MTOSI to compute the rest of the path.
It is noted that in order to reduce the number of protocol conversions, this conversion is used only once, i.e. from PCECP to MTOSI; the rest of the path may preferably be computed using only MTOSI. It is further noted that a request initialized by a domain without a PCE would be a MTOSI request and may preferably not be converted into a PCECP request by its intermediate (adjacent) domain.
A path setup during a migration phase can still be signaled between the SMSs, and each SMS may instruct the NMS and/or the CP to setup the corresponding path segment. As an alternative, without a standardized MTOSI available between SMSs, the path computation could still be facilitated by traditional fax or email based mechanisms.

### Further Implementation Details

### (1) Multi-Domain Path Computation:

Computation (merely) inside the SMSs:
In this case, the whole path computation can be processed by the at least one SMS. A first SMS, which is responsible for a source domain, computes the domain chain using information of reachability. This first SMS triggers computation of the paths for other domains either directly or indirectly. In the direct case, the first SMS sends a corresponding request towards the other SMSs and preferably receives a sub-path for each domain from the other SMSs. In the indirect case, the first SMS triggers only a subsequent domain. The corresponding SMS of this subsequent domain may then trigger the SMS of another subsequent domain and so on. The first SMS may receive a message from the second SMS comprising the path starting at the edge of the source domain. It could depend on an SLA whether the direct or indirect case is selected. It is noted that such path computation approach may be similar to the path computation approach as explained above.
Collaboration of PCE(s) and SMSs:
In this embodiment, both the SMSs and PCEs are involved:
   Collaboration of PCEs for calculating the whole multi-domain path:
   With this approach, the path computation is processed by a collaboration of PCEs of the different domains. The SMS of the first domain provides reachability information to the PCE of the first domain and asks for the whole multi-domain path. The domain chain is then calculated by the first PCE. As an alternative, the SMS may request a multi-domain path computation from the first PCE, but may additionally specify the domain chain. In both cases, the PCE of the first domain computes in direct collaboration with PCEs of other domains the (optimal) path across several domains. BRPC can be used for such computation.
   Collaboration of SMSs:
   Each SMS may trigger the PCE for computing a path for a single domain. In this approach, the SMS computes the domain chain. Furthermore, the first SMS triggers either directly or indirectly the path computation from the other domain by communicating with the other SMSs. Each SMS may then forward the path computation request to its associated PCE. The PCE calculates the path for its (single) domain. This information is sent back either directly or indirectly to the first SMS.

### (2) Multi-Layer Path Computation:

A multi-layer path can be set up as follows:
   The SMS triggers a path setup of a multi-layer path between a node A and a node B (of a single domain).
   This request is forwarded to the corresponding NMS, which manages the nodes A and B.
   Based on this request, the NMS may generate a path computation request, which is forwarded to the PCE.
   The PCE may compute a (preferably, in particular optimal) multi-layer path between said nodes A and B, taking into account information from several (in particular all) layers of the domain.
   This computed path is sent back to the NMS.
This approach could be different depending on whether the MP-based or the CP-based approach is used:
   MP approach:
   In this approach, the NMS is a multi-layer NMS. Therefore, the NMS is aware of all nodes in all different layers. Hence, the NMS may configure via the EMS and SNMP all nodes in their different layers to setup the path.
   CP approach:
   Here, each NMS has only knowledge about a single layer. Therefore, the NMS may trigger the path setup via SNMP. However, the actual path setup can be provided by the CP via a signaling protocol, e.g., RSVP-TE.

### Further Advantages:

a) Fully automated multi-domain connection computation and connection establishment can be provided, which leads to fast connection provisioning.
b) The approach provides a fully integrated solution for optimal path computation in multi-layer, multi-domain, multi-vendor and/or multi-technology environments.
c) A PCE to SMS communication is available thereby in particular forwarding multi-layer path computation requests.
d) A functional split of tasks and databases between the components NMS, CP, PCE is provided. This efficiently allows for better scaling of signaling and synchronization.
e) It is possible to use only a single database throughout the system. This reduces redundancy, overhead, memory and CPU required, signaling efforts as well as synchronization efforts.
f) The modular concept of the components NMS, PCE, CP further reduces an overall complexity as updating these modules is simplified.

Hence, the approach provided in particular significantly decreases OPEX and CAPEX.

### LIST OF ABBREVIATIONS

### BGP Border Gateway Protocol

### BRPC Backward Recursive PCE-Based Computation

CAPEX Capital expenditures

### CP Control Plane

### CPU Central Processing Unit

### DB Database

### DWDM Dense Wavelength Division Multiplexing

e2e end-to-end

### EMS Element Management System

### E-NNI External Network-to-Network Interface

### FCAPS Fault, Configuration, Accounting, Performance, Security

### GMPLS Generalized Multiprotocol Label Switching

### IGP Interior Gateway Protocol

### IP Internet Protocol

MD Multi domain

### MIB Management Information Base

ML Multi layer

### MP Management Plane

### MTOSI Multi-Technology Operations System Interface

### NE Network Element

### NMS Network Management System

OPEX Operation expenditures

### OSI Open System Interconnection

### OSPF-TE Open Shortest Path First-Traffic Engineering

### PCC Path Computation Client

### PCE Path Computation Element

### PCECP Path Computation Element Communication Protocol

### SDH Synchronous Digital Hierarchy

### SLA Service Level Agreement

### SMS Service Management System

### SNMP Simple Network Management Protocol

### TED Traffic Engineering Database

TMF TeleManagement Forum

1-15. (canceled)

16. A method of processing data in a network domain, the method which comprises:
determining resources of several layers of at least two network elements of the network domain; and
utilizing the resources thus determined for path processing in the network domain.

17. The method according to claim 16, wherein the path processing comprises path computation and/or routing across the network domain or preparatory actions thereof.

18. The method according to claim 16, wherein said path processing in the network domain comprises a connection setup.

19. The method according to claim 16, which comprises determining the resources by a centralized component of the network domain.

20. The method according to claim 19, which comprises determining the resources by a path computation element.

21. The method according to claim 16, which comprises determining the resources via at least one control plane and/or via at least one management plane of the network domain.

22. The method according to claim 21, wherein the management plane comprises one or more systems selected from the group consisting of
a service management system;
a network management system;
an element management system.

23. The method according to claim 21, wherein the management plane and/or the control plane provides one or more of the services selected from the group consisting of:
fault management;
configuration services;
accounting services;
performance services;
security services.

24. The method according to claim 21, wherein the network element includes a management plane functionality.

25. The method according to claim 21, which comprises provided with the management plane and/or the control plane one or more of the following functions:
a determination of adjacent network elements and/or domains;
a distribution of topology and/or resource status information;
a path computation functionality;
routing functions;
signaling functions.

26. The method according to claim 25, which comprises supplying the control plane within a GMPLS implementation for several layers of the network elements.

27. The method according to claim 16, which comprises processing a path across several domains utilizing the resources determined in the network domain.

28. The method according to claim 16, wherein:
the determining step comprises determining the resources at least partially by several centralized components;
each centralized component is a computation element of one domain; and
the computation elements of several domains collaborate with each other to determine resources that are used for path processing purposes across several domains of the network.

29. A device, comprising a processing unit configured to execute thereon the method according to claim 16.

30. A device associated with a processing unit configured to execute the method according to claim 16.

31. The device according to claim 29, formed as a network element.

32. The device according to claim 29, configured as a node of a communication network.

33. A communication system, comprising at least one device according to claim 28.
